(19) United States
(12) Patent Application Publication
(10) Pub. No.: US 2024/0174804 A1
(43) Pub. Date: May 30, 2024

(54) COMPOSITION AND METHOD FOR PRODUCING COMPOSITION

(71) Applicant: AGC Inc., Tokyo (JP)

(72) Inventors: Masatoshi ABE, Tokyo (JP); Toru SASAKI, Tokyo (JP); Masahide YODOGAWA, Tokyo (JP)

(73) Assignee: AGC Inc., Tokyo (JP)

(21) Appl. No.: 18/433,745

(22) Filed: Feb. 6, 2024

Related U.S. Application Data
(63) Continuation of application No. PCT/JP2022/030527, filed on Aug. 10, 2022.

(30) Foreign Application Priority Data
Aug. 17, 2021 (JP) 2021-132532

(51) Int. Cl. C08G 65/48; C08J 7/12

(52) U.S. Cl. CPC C08G 65/48; C08J 7/123; C08J 2371/08

(57) ABSTRACT

Provided is a composition including a fluorine-containing polymer and a polyaryletherketone, in which the fluorine-containing polymer is dispersed in the polyaryletherketone, and a storage elastic modulus G′ of the composition at a melting point of the polyaryletherketone is 0.1 MPa or more.

This application is a continuation application of International Application No. PCT/JP2022/030527, filed on Aug. 10, 2022, which claims the benefit of priority of the prior Japanese Patent Application No. 2021-132532, filed in Japan on Aug. 17, 2021, the entire contents of which are incorporated herein by reference.

### BACKGROUND OF THE INVENTION

### Field of the Invention

The present invention relates to a composition and a method for producing a composition.

### Description of Related Art

Polyaryletherketone (polyetheretherketone, polyetherketone, polyetherketoneketone, or the like) is a material with excellent chemical stability, heat stability, and ionizing radiation resistance and is used in various fields.

Crosslinking of polyaryletherketone has been studied (Patent Document 1).

### RELATED ART DOCUMENT

### Patent Document

[Patent Document 1] Published Japanese Translation No. 2015-504463 of the PCT International Publication

### SUMMARY OF THE INVENTION

### Technical Problem

However, polyaryletherketone does not have sufficient resistance to sagging (hereinafter, also referred to as “anti-drip properties”) in a case where a resin is melted.

It is considered that crosslinking of polyaryletherketone as in Patent Document 1 is effective for improving anti-drip properties. However, in Patent Document 1, it is necessary to mix a specific crosslinking compound in order to crosslink the polyaryletherketone, and an annealing treatment at a high temperature (for example, 250° C.) is required for crosslinking. For this reason, there is a problem that the excellent physical properties (for example, mechanical physical properties) of the polyaryletherketone are impaired due to the addition of a low molecular weight crosslinking compound and the influence of heat, resulting in an increase in cost.

A method of carrying out irradiation with ionizing radiation is also known as a method for crosslinking a resin.

However, polyaryletherketone also has very good ionizing radiation resistance, and in the method of irradiation with ionizing radiation, the polyaryletherketone is not crosslinked, or even if it is crosslinked, it is only slightly crosslinked, and thus sufficient anti-drip properties cannot be obtained.

The present invention provides a composition based on a polyaryletherketone and having excellent anti-drip properties, and a method for producing the same.

### Solution to Problem

The present invention has the following aspects.

[1] A composition including a fluorine-containing polymer and a polyaryletherketone, in which the fluorine-containing polymer is dispersed in the polyaryletherketone, and a storage elastic modulus G′ of the composition at a melting point of the polyaryletherketone is 0.1 MPa or more.

[2] The composition according to [1], in which the fluorine-containing polymer has no melting point.

[3] The composition according to [1] or [2], in which a Mooney viscosity (ML₁₊₁₀, 121ºC) of the fluorine-containing polymer is 10 to 300.

[4] The composition according to any one of [1] to [3], in which the melting point of the polyaryletherketone is 340° C. or higher.

[5] The composition according to any one of [1] to [4], in which, in a TMA curve measured in accordance with JIS K 7196 for a sample consisting of the composition, an absolute value of a sample deformation amount at the melting point of the polyaryletherketone is 150 μm or less.

[6] A method for producing a composition, the method including irradiating a composition precursor with ionizing radiation, in which the composition precursor contains a fluorine-containing polymer and a polyaryletherketone, the fluorine-containing polymer is dispersed in the polyaryletherketone, the composition precursor does not have a storage elastic modulus G′ at a melting point of the polyaryletherketone, and an irradiation amount of the ionizing radiation is set so that the storage elastic modulus G′ of the composition at the melting point of the polyaryletherketone is 0.1 MPa or more in a case where the composition precursor is irradiated with the ionizing radiation.

[7] The method for producing a composition according to [6], in which the composition precursor satisfies the following requirement 1.

Requirement 1: A tensile strength after irradiation of the composition precursor with 10 MGy of ionizing radiation is 1.1 times or more with respect to a tensile strength before the irradiation.

[8] The method for producing a composition according to [6] or [7], in which the composition precursor satisfies the following requirement 2.

Requirement 2: A tensile elongation after irradiation of the composition precursor with 1 MGy of ionizing radiation is 0.85 times or less with respect to a tensile elongation before the irradiation.

[9] The method for producing a composition according to any one of [6] to [8], in which the composition precursor satisfies the following requirement 3.

Requirement 3: A tensile elongation after irradiation of the composition precursor with 5 MGy of ionizing radiation is 0.85 times or less with respect to a tensile elongation before the irradiation.

[10] The method for producing a composition according to any one of [6] to [9], in which the composition precursor satisfies the following requirement 4.

Requirement 4: A tensile elongation after irradiation of the composition precursor with 10 MGy of ionizing radiation is 0.75 times or less with respect to a tensile elongation before the irradiation.

The present invention also has the following aspects.

[1] A composition including a fluorine-containing polymer and a polyaryletherketone, in which a crosslinked structure is formed between the fluorine-containing polymer and the polyaryletherketone.

[2] The composition according to [1], in which the crosslinked structure is preferably a crosslinked structure formed by a radical reaction; and is preferably a crosslinked structure formed by a reaction between active radical species or unsaturated bonds generated by decomposition of the polyaryletherketone and active radical species or unsaturated bonds generated by decomposition of the fluorine-containing polymer, by irradiation with ionizing radiation.

[3] The composition according to [1] or [2], in which the crosslinked structure contains an alkyl group having a tertiary hydroxyl group.

[4] The composition according to any one of [1] to [3], in which a proportion of the fluorine-containing polymer is preferably 1% to 40% by mass, more preferably 5% to 35% by mass, and still more preferably 10% to 30% by mass with respect to a total mass of the composition.

[5] The composition according to any one of [1] to [4], in which a proportion of the polyaryletherketone is preferably 60% to 99% by mass, more preferably 65% to 95% by mass, and still more preferably 70% to 90% by mass with respect to a total mass of the composition.

[6] The composition according to any one of [1] to [5], in which a storage elastic modulus G′ of the composition at a melting point of the polyaryletherketone is 0.1 MPa or more, preferably 0.2 to 3,000 MPa, more preferably 0.5 to 1,000 MPa, and still more preferably 0.7 to 100 MPa.

[7] The composition according to any one of [1] to [6], in which the fluorine-containing polymer is a fluorine-containing elastic copolymer exhibiting a storage elastic modulus G′ of 80 or more at 100° C. and 50 cpm and having no Tm; preferably at least one copolymer selected from the group consisting of a copolymer containing a tetrafluoroethylene unit and a propylene unit, a copolymer containing a hexafluoropropylene unit and a vinylidene fluoride unit, and a copolymer containing a tetrafluoroethylene unit and a perfluoro(alkyl vinyl ether) unit; more preferably a copolymer containing a tetrafluoroethylene unit and a propylene unit; and particularly preferably a copolymer consisting of a tetrafluoroethylene unit and a propylene unit.

[8] The composition according to any one of [1] to [7], in which a Mooney viscosity (ML₁₊₁₀, 121° C.) of the fluorine-containing polymer is preferably 10 to 300, more preferably 20 to 280, and still more preferably 30 to 250.

[9] The composition according to any one of [1] to [8], in which a storage elastic modulus G′ of the fluorine-containing polymer at 100° C. and 50 cpm is preferably 80 or more and 500 or less, more preferably 150 or more and 450 or less, and still more preferably 200 or more and 400 or less.

[10] The composition according to any one of [1] to [9], in which the polyaryletherketone is preferably at least one selected from the group consisting of a polyetherketone, a polyetheretherketone, and a polyetherketoneketone; and more preferably a polyetheretherketone.

[11] The composition according to any one of [1] to [10], in which a melting point of the polyaryletherketone is preferably 280° C. or higher and 420° C. or lower, and more preferably 343° C. or higher and 380° C. or lower.

[12] The composition according to any one of [1] to [11], in which an MFR of the polyaryletherketone is preferably 1 to 200 g/10 min, and more preferably 3 to 100 g/10 min.

[13] The composition according to any one of [1] to [12], in which, with respect to a sample consisting of the composition, an absolute value of a sample deformation amount in a case of being measured by an evaluation method of a heat deformation resistance test described in Examples is preferably 0 μm or more and 150 μm or less, more preferably 0 μm or more and 100 μm or less, and still more preferably 0 μm or more and 70 μm or less.

[14] The composition according to any one of [1] to [13], in which an MFR of the composition in a case of being measured in accordance with ASTM D1238 under the conditions of a temperature of 372° C. and a load of 49 N is preferably 0.000001 g/10 min or more and 15.0 g/10 min or less, more preferably 0.0001 g/10 min or more and 10.0 g/10 min or less, still more preferably 0.001 g/10 min or more and 5.0 g/10 min or less, and particularly preferably 0.01 g/10 min or more and 1.0 g/10 min or less.

[15] The composition according to any one of [1] to [14], in which the composition is a product obtained by irradiating a composition precursor with ionizing radiation, the composition precursor contains a fluorine-containing polymer and a polyaryletherketone, and it is preferable that no crosslinked structure is formed between the fluorine-containing polymer and the polyaryletherketone in the composition precursor; and it is more preferable that the composition precursor contains neither a structure derived from a crosslinking agent nor a structure derived from a crosslinking aid.

[16] The composition according to [15], in which an MFR of the composition precursor is preferably 2 to 300 g/10 min, more preferably 3 to 200 g/10 min, and still more preferably 5 to 100 g/10 min.

[17] The composition according to [15] or [16], in which a tensile strength after irradiation of the composition precursor with 10 MGy of ionizing radiation is preferably more than 1.0 times and 5 times or less, more preferably 1.1 times or more and 3 times or less, and still more preferably 1.2 times or more and 2 times or less with respect to a tensile strength before the irradiation.

[18] The composition according to any one of [15] to [17], in which a tensile elongation after irradiation of the composition precursor with 1 MGy of ionizing radiation is preferably more than 0 times and 1.5 times or less, more preferably 0.2 times or more and 0.84 times or less, and still more preferably 0.3 times or more and 0.6 times or less with respect to a tensile elongation before the irradiation.

[19] The composition according to any one of [15] to [18], in which a tensile elongation after irradiation of the composition precursor with 5 MGy of ionizing radiation is preferably more than 0 times and 0.85 times or less, more preferably 0.05 times or more and 0.5 times or less, and still more preferably 0.1 times or more and 0.4 times or less with respect to a tensile elongation before the irradiation.

[20] The composition according to any one of [15] to [19], in which a tensile elongation after irradiation of the composition precursor with 10 MGy of ionizing radiation is preferably more than 0 times and 0.75 times or less, more preferably 0.01 times or more and 0.3 times or less, and still more preferably 0.03 times or more and 0.2 times or less with respect to a tensile elongation before the irradiation.

[21] The composition according to any one of [15] to [20], in which a relationship among a tensile elongation (Ea1) after irradiation of the composition precursor with 1 MGy of ionizing radiation, a tensile elongation (Ea5) after irradiation of the composition precursor with 5 MGy of ionizing radiation, and a tensile elongation (Ea10) after irradiation of the composition precursor with 10 MGy of ionizing radiation satisfies Ea1>Ea5>Ea10.

[22] The composition according to any one of [15] to [21], in which a relationship between a melt mass flow rate (MFR_{CP}) of the composition precursor in a case of being measured in accordance with ASTM D1238 under the conditions of a temperature of 372° C. and a load of 49 N and a melt mass flow rate (MFR_{C}) of the composition in a case of being measured in accordance with ASTM D1238 under the conditions of a temperature of 372° C. and a load of 49 N preferably satisfies 0<MFR_{C}/MFR_{CP}<1.0, more preferably satisfies 0<MFR_{C}/MFR_{CP}<0.1, and still more preferably satisfies 0<MFR_{C}/MFR_{CP}<0.01.

[23] The composition according to any one of [1] to [22], in which the composition preferably consists essentially of the fluorine-containing polymer and the polyaryletherketone; and the composition more preferably consists of the fluorine-containing polymer and the polyaryletherketone.

[24] Use of a composition precursor in the production of the composition according to any one of [1] to [23] that is obtained by irradiating the composition precursor with ionizing radiation, in which the composition precursor contains a fluorine-containing polymer and a polyaryletherketone, and no crosslinked structure is formed between the fluorine-containing polymer and the polyaryletherketone.

### Advantageous Effects of Invention

According to the present invention, it is possible to provide a composition based on a polyaryletherketone and having excellent anti-drip properties, and a method for producing the same.

### DETAILED DESCRIPTION OF THE INVENTION

The meanings and definitions of terms in the present invention are as follows.

The “storage elastic modulus G′” is a value measured in accordance with ASTM D6204.

The “melting point” is a temperature corresponding to a maximum value of a melting peak measured by a differential scanning calorimetry (DSC) method. Hereinafter, the melting point is also referred to as Tm.

The “Mooney viscosity (ML₁₊₁₀, 121° C.)” is a value measured in accordance with JIS K 6300-1:2000 (corresponding international standards ISO 289-1:2005 and ISO 289-2:1994).

Each of “tensile strength” and “tensile elongation” is a value obtained by preparing a dumbbell-shaped test piece (thickness: 1 mm) specified in ASTM D638 TYPE V from a sample (a composition precursor before or after irradiation with ionizing radiation) and carrying out a tensile test on this test piece in accordance with ASTM D638.

The “melt flow rate” is a melt mass flow rate measured in accordance with ASTM D1238. Hereinafter, the melt flow rate is also referred to as MFR. The MFR measurement conditions are a temperature of 372° C. and a load of 49 N.

The “unit based on a monomer” is a generic term for an atomic group directly formed by polymerization of one molecule of a monomer and an atomic group obtained by chemical conversion of a part of the atomic group after polymerization. In the present specification, the unit based on a monomer is also simply referred to as a monomer unit. For example, the unit based on TFE is also referred to as a TFE unit.

The “monomer” refers to a compound having a polymerizable carbon-carbon double bond.

### [Composition]

A composition according to an embodiment of the present invention (hereinafter, also referred to as the present composition) includes a fluorine-containing polymer and a polyaryletherketone (hereinafter, also referred to as PAEK).

The present composition may include components other than the fluorine-containing polymer and PAEK (hereinafter, also referred to as other components), as necessary, within a range that does not impair the effect of the present invention.

The present composition has a storage elastic modulus G′ in a case of being measured at a Tm of PAEK. The storage elastic modulus G′ of the present composition in a case of being measured at the Tm of PAEK is 0.1 MPa or more, preferably 0.2 to 3,000 MPa, more preferably 0.5 to 1,000 MPa, and still more preferably 0.7 to 100 MPa.

The fact that the present composition has a storage elastic modulus G′ in a case of being measured at the Tm of PAEK means that the storage elastic modulus G′ is more than 0 MPa and indicates that the present composition has a crosslinked structure. The higher the crosslinking density, the higher the storage elastic modulus G′ tends to be. In a case where the storage elastic modulus G′ is equal to or more than the lower limit value, the crosslinking density of the present composition is sufficiently high, the anti-drip properties are excellent, and the tensile strength and the dimensional stability are also favorable. In a case where the storage elastic modulus G′ is equal to or less than the upper limit value, the tensile elongation and the flexibility are favorable.

In the present composition, the fluorine-containing polymer is dispersed in PAEK. As a result, a crosslinked structure can be introduced while sufficiently maintaining the excellent properties (heat resistance and the like) of PAEK.

The number average particle diameter of the fluorine-containing polymer dispersed in PAEK is preferably 0.5 to 10 μm and more preferably 1 to 5 μm. In a case where the number average particle diameter of the fluorine-containing polymer is equal to or more than the lower limit value, the impact resistance and the abrasion resistance of the present composition are more excellent, and in a case where the number average particle diameter of the fluorine-containing polymer is equal to or less than the upper limit value, the dispersion uniformity of the fluorine-containing polymer is more excellent.

The “number average particle diameter” of the fluorine-containing polymer in the composition is a value obtained by observing a molded body of the composition with a scanning electron microscope, measuring maximum diameters of 100 randomly selected particles, and taking an arithmetic average of the measured values.

In the present composition, a proportion of the fluorine-containing polymer with respect to a total mass of the fluorine-containing polymer and PAEK is preferably 1% to 60% by mass, more preferably 5% to 40% by mass, and still more preferably 10% to 30% by mass. In a case where the proportion of the fluorine-containing polymer is equal to or more than the lower limit value, the crosslinking density of the present composition can be sufficiently increased, and in a case where the proportion of the fluorine-containing polymer is equal to or less than the upper limit value, the fluorine-containing polymer can be easily dispersed in PAEK, and the excellent properties (stiffness and the like) of PAEK can be exhibited.

The proportion of the total mass of the fluorine-containing polymer and PAEK with respect to the total mass of the present composition is preferably 10% by mass or more, more preferably 50% by mass or more, and still more preferably 70% by mass or more, and may be 100% by mass.

The MFR of the present composition is preferably 1.0 g/10 min or less and more preferably 0.5 g/10 min or less. In addition, the MFR of the present composition is preferably 0.000001 g/10 min or more and more preferably 0.0001 g/10 min or more. In a case where the MFR of the present composition is equal to or less than the upper limit value, the anti-drip properties and the tensile strength are more excellent. In a case where the MFR of the present composition is equal to or more than the lower limit value, the tensile elongation and the flexibility are more excellent.

The present composition is typically obtained by irradiating a composition precursor including a fluorine-containing polymer and PAEK with ionizing radiation. A crosslinked structure is formed by irradiating the composition precursor with ionizing radiation. The method for producing the present composition by irradiation with ionizing radiation will be described in detail later.

### (Fluorine-Containing Polymer)

It is preferable that the fluorine-containing polymer has no Tm from the viewpoint of flexibility.

The fluorine-containing polymer having no Tm is typically a fluorine-containing elastomer.

The fluorine-containing elastomer is a fluorine-containing elastic copolymer having no Tm and exhibiting a storage elastic modulus G′ of 80 or more at 100° C. and 50 cpm, and is distinguished from a fluororesin.

A fluorine-containing elastic copolymer having one or more types of units based on the following monomer m1 is preferable as the fluorine-containing elastomer.

The monomer m1 is at least one monomer selected from the group consisting of tetrafluoroethylene (hereinafter, also referred to as TFE), hexafluoropropylene (hereinafter, also referred to as HFP), vinylidene fluoride (hereinafter, also referred to as VdF), and chlorotrifluoroethylene (hereinafter, also referred to as CTFE).

Although two or more types of fluorine-containing elastomers may be used in combination, it is preferable to use one type of fluorine-containing elastomer alone.

The fluorine-containing elastomer may be a fluorine-containing elastic copolymer having two or more types of units based on the monomer m1, or may be a fluorine-containing elastic copolymer having one or more types of units based on the monomer m1 and one or more types of units based on the following monomer m2 which can be copolymerized with the monomer m1.

The monomer m2 is at least one monomer selected from the group consisting of ethylene (hereinafter, also referred to as E), propylene (hereinafter, also referred to as P), perfluoro(alkyl vinyl ether) (hereinafter, also referred to as PAVE), vinyl fluoride (hereinafter, also referred to as VF), 1,2-difluoroethylene (hereinafter, also referred to as DiFE), 1,1,2-trifluoroethylene (hereinafter, also referred to as TrFE), 3,3,3-trifluoro-1-propylene (hereinafter, also referred to as TFP), 1,3,3,3-tetrafluoropropylene, and 2,3,3,3-tetrafluoropropylene.

PAVE is a compound represented by Formula 1.

CF₂—CF(OR^{F}) Formula 1

In this regard, RF is a linear or branched perfluoroalkyl group having 1 to 8 carbon atoms.

Examples of PAVE include perfluoro(methyl vinyl ether) (hereinafter, also referred to as PMVE), perfluoro(ethyl vinyl ether) (hereinafter, also referred to as PEVE), perfluoro(propyl vinyl ether) (hereinafter, also referred to as PPVE), and perfluoro(butyl vinyl ether) (hereinafter, also referred to as PBVE).

The fluorine-containing elastomer may have one or more types of units based on a monomer other than the monomer m1 and the monomer m2 (hereinafter, also referred to as monomer m3), which can be copolymerized with the monomer m1 and whose copolymer with the monomer m1 is an elastic copolymer.

The proportion of the units based on the monomer m3 is preferably 20 mol % or less, more preferably 5 mol % or less, and particularly preferably 0 mol % with respect to all the units constituting the fluorine-containing elastomer.

The fluorine-containing elastomer is preferably such that all the units constituting the fluorine-containing elastomer consist of two or three types of units based on the monomer m1, or consist of one or more types of units based on the monomer m1 and one or more types of units based on the monomer m2. In this regard, the fluorine-containing elastomer may have a unit other than these units as an impurity or the like as long as it does not affect the properties of the present composition.

Examples of the fluorine-containing elastomer include the following three types of copolymers. Here, the proportion of the total of each of the units specifically shown in the following three types of copolymers is preferably 50 mol % or more with respect to all the units constituting the copolymers.

A copolymer having a TFE unit and a P unit (hereinafter, also referred to as a TFE/P-containing copolymer).

A copolymer having an HFP unit and a VdF unit (provided that a copolymer having a P unit is excluded) (hereinafter, also referred to as a HFP/VdF-containing copolymer).

A copolymer having a TFE unit and a PAVE unit (provided that a copolymer having a P unit or a VdF unit is excluded) (hereinafter, also referred to as a TFE/PAVE-containing copolymer).

Examples of the TFE/P-containing copolymer include the following.

TFE/P (meaning a copolymer consisting of a TFE unit and a P unit. The same applies to others), TFE/P/VF, TFE/P/VdF, TFE/P/E, TFE/P/TFP, TFE/P/PAVE, TFE/P/1,3,3,3-tetrafluoropropene, TFE/P/2,3,3,3-tetrafluoropropene, TFE/P/TrFE, TFE/P/DiFE, TFE/P/VdF/TFP, and TFE/P/VdF/PAVE, among which TFE/P is preferable.

Examples of the HFP/VdF-containing copolymer include HFP/VdF, TFE/VdF/HFP, TFE/VdF/HFP/TFP, TFE/VdF/HFP/PAVE, VdF/HFP/TFP, and VdF/HFP/PAVE, among which HFP/VdF is preferable.

Examples of the TFE/PAVE-containing copolymer include TFE/PAVE. In particular, TFE/PMVE and TFE/PMVE/PPVE in which PAVE is PMVE or PPVE are preferable, and TFE/PMVE is particularly preferable.

Other examples of the fluorine-containing elastomer include TFE/VdF/2,3,3,3-tetrafluoropropylene, VdF/PAVE, VdF/2,3,3,3-tetrafluoropropylene, and E/HFP.

The fluorine-containing elastomer is preferably a TFE/P-containing copolymer, an HFP/VdF-containing copolymer, or a TFE/PAVE-containing copolymer, more preferably a TFE/P-containing copolymer, and particularly preferably TFE/P. TFE/P has favorable heat stability during melt-kneading and stable transportability during melt-kneading. In addition, TFE/P has reduced coloring and foaming of a molded body.

The proportion of each of the units constituting the fluorine-containing elastomer is preferably in the following range from the viewpoint of easily contributing to impact resistance of the molded body.

The molar ratio of each of the units in TFE/P (TFE:P. The same applies hereinafter) is preferably 30 to 80:70 to 20, more preferably 40 to 70:60 to 30, and still more preferably 50 to 60:50 to 40.

In TFE/P/VF, TFE:P:VF is preferably 30 to 60:60 to 20:0.05 to 40.

In TFE/P/VdF, TFE:P:VdF is preferably 30 to 60:60 to 20:0.05 to 40.

In TFE/P/E, TFE:P:E is preferably 20 to 60:70 to 30:0.05 to 40.

In TFE/P/TFP, TFE:P:TFP is preferably 30 to 60:60 to 30:0.05 to 20.

In TFE/P/PAVE, TFE:P:PAVE is preferably 40 to 70:60 to 29.95:0.05 to 20.

In TFE/P/1,3,3,3-tetrafluoropropene, TFE:P:1,3,3,3-tetrafluoropropene is preferably 30 to 60:60 to 20:0.05 to 40.

In TFE/P/2,3,3,3-tetrafluoropropene, TFE:P:2,3,3,3-tetrafluoropropene is preferably 30 to 60:60 to 20:0.05 to 40.

In TFE/P/TrFE, TFE:P:TrFE is preferably 30 to 60:60 to 20:0.05 to 40.

In TFE/P/DiFE, TFE:P:DiFE is preferably 30 to 60:60 to 20:0.05 to 40.

In TFE/P/VdF/TFP, TFE:P:VdF:TFP is preferably 30 to 60:60 to 20:0.05 to 40:0.05 to 20.

In TFE/P/VdF/PAVE, TFE:P:VdF:PAVE is preferably 30 to 70:60 to 20:0.05 to 40:0.05 to 20.

In HFP/VdF, HFP:VdF is preferably 99 to 5:1 to 95.

In TFE/VdF/HFP, TFE:VdF:HFP is preferably 20 to 60:1 to 40:20 to 60.

In TFE/VdF/HFP/TFP, TFE: VdF:HFP:TFP is preferably 30 to 60:0.05 to 40:60 to 20:0.05 to 20.

In TFE/VdF/HFP/PAVE, TFE: VdF:HFP:PAVE is preferably 30 to 70:60 to 20:0.05 to 40:0.05 to 20.

In VdF/HFP/TFP, VdF:HFP:TFP is preferably 1 to 90:95 to 5:0.05 to 20.

In VdF/HFP/PAVE, VdF:HFP:PAVE is preferably 20 to 90:9.95 to 70:0.05 to 20.

In TFE/PAVE, TFE:PAVE is preferably 40 to 70:60 to 30.

In addition, in a case where PAVE is PMVE, TFE:PMVE is preferably 40 to 70:60 to 30.

In TFE/PMVE/PPVE, TFE:PMVE:PPVE is preferably 40 to 70:3 to 57:3 to 57.

In TFE/VdF/2,3,3,3-tetrafluoropropylene, TFE:VdF:2,3,3,3-tetrafluoropropylene is preferably 1 to 30:30 to 90:5 to 60.

In VdF/PAVE, VdF:PAVE is preferably 3 to 95:97 to 5.

In VdF/2,3,3,3-tetrafluoropropylene, VdF:2,3,3,3-tetrafluoropropylene is preferably 30 to 95:70 to 5.

In E/HFP, E:HFP is preferably 40 to 60:60 to 40.

The fluorine content in the fluorine-containing polymer is preferably 50% to 74% by mass and more preferably 55% to 70% by mass. The fluorine content is preferably 57% to 60% by mass in TFE/P, preferably 66% to 71% by mass in HFP/VdF, and preferably 66% to 70% by mass in TFE/PMVE. In a case where the fluorine content is equal to or more than the lower limit value, the heat resistance and the chemical resistance of the present composition are more excellent, and in a case where the fluorine content is equal to or less than the upper limit value, the impact resistance of the present composition is more excellent.

The fluorine content in the fluorine-containing polymer indicates the proportion of the mass of fluorine atoms with respect to the total mass of all atoms constituting the fluorine-containing polymer. The fluorine content is calculated from the molar ratio of each unit in the fluorine-containing polymer, which is obtained by melt NMR measurement and total fluorine content measurement.

The Mooney viscosity (ML₁₊₁₀, 121° C.) of the fluorine-containing polymer is preferably 10 to 300, more preferably 20 to 280, and still more preferably 30 to 250. The Mooney viscosity is a scale of molecular weight; a high Mooney viscosity value indicates a high molecular weight, and a low Mooney viscosity value indicates a low molecular weight. In a case where the Mooney viscosity of the fluorine-containing polymer is equal to or more than the lower limit value, the impact resistance is more excellent, and in a case where the Mooney viscosity of the fluorine-containing polymer is equal to or less than the upper limit value, the workability is more excellent.

The fluorine-containing polymer may be a commercially available fluorine-containing polymer, or may be a fluorine-containing polymer produced from various raw materials by a conventionally known method.

For example, the fluorine-containing elastomer can be produced by polymerizing one or more types of the monomer m1, and as necessary, one or more types of one or both of the monomer m2 and the monomer m3.

Examples of the polymerization method include an emulsion polymerization method, a solution polymerization method, a suspension polymerization method, and a bulk polymerization method. An emulsion polymerization method in which monomers are polymerized in the presence of an aqueous medium and an emulsifier is preferable from the viewpoint that the number average molecular weight of the fluorine-containing elastic copolymer and the copolymer composition are easily adjusted and the productivity is excellent.

In the emulsion polymerization method, monomers are polymerized in the presence of an aqueous medium, an emulsifier, and a radical polymerization initiator to obtain an elastomer latex. A pH adjuster may be added during the polymerization of the monomer.

### (PAEK)

From the viewpoint of mechanical properties and heat resistance, PAEK is preferably a polyetherketone (hereinafter, also referred to as PEK), a polyetheretherketone (hereinafter, also referred to as PEEK), or a polyetherketoneketone (hereinafter, also referred to as PEKK), and particularly preferably PEEK. Although two or more types of PAEK may be used in combination, it is preferable to use one type of PAEK alone.

The Tm of PAEK is, for example, 280° C. or higher, preferably 340° C. or higher, and more preferably 343° C. or higher. In addition, the Tm of PAEK is preferably 420° C. or lower and more preferably 380° C. or lower. In a case where the Tm of PAEK is 340° C. or higher, the strength is more excellent. In a case where the Tm of PAEK is 420° C. or lower, the workability is more excellent.

The MFR of PAEK is preferably 1 to 200 g/10 min, and more preferably 3 to 100 g/10 min. In a case where the MFR of PAEK is equal to or more than the lower limit value, the workability is more excellent, and in a case where the MFR of PAEK is equal to or less than the upper limit value, the strength is more excellent.

PAEK may be commercially available PAEK or may be PAEK produced from various raw materials by a conventionally known method. Examples of commercially available products of PEEK include Victrex PEEK (manufactured by Victrex plc.), VestaKeep (manufactured by Evonik Industries AG), and Ketaspire (manufactured by Solvay Specialty Polymers, LLC.). Examples of commercially available products of PEKK include Kepstan (manufactured by Arkema S.A.).

### (Other Components)

Examples of other components include additives such as an inorganic filler, a polymer filler, a plasticizer, and a flame retardant. The other components may be used alone or in combination of two or more thereof.

Examples of the inorganic filler include a glass fiber, a carbon fiber, graphite, graphene, a carbon nanotube, a gypsum fiber, mica, talc, a glass flake, wollastonite, potassium titanate, aluminum borate, boron nitride, aluminum nitride, calcium carbonate, silicon oxide (silica), titanium oxide, barium sulfate, zinc oxide, aluminum hydroxide, magnesium hydroxide, clay, white carbon, carbon black, an inorganic pigment, molybdenum disulfide, a metal powder, a magnetic material, and zeolite.

Examples of the glass fiber include a chopped fiber, a milled fiber, and a flat glass fiber having a modified cross section. In addition, a glass fiber having a low dielectric constant can also be used from the viewpoint of electrical properties.

Examples of the carbon fiber include a PAN-based carbon fiber, a pitch-based isotropic carbon fiber, and a pitch-based anisotropic carbon fiber. As for the shape of the carbon fiber, a chopped fiber or a milled fiber can be selected depending on the desired physical properties.

Examples of the carbon black include furnace black, acetylene black, thermal black, and channel black. Among these, furnace black is preferable. Examples of the furnace black include HAF-LS carbon, HAF carbon, HAF-HS carbon, FEF carbon, GPF carbon, APF carbon, SRF-LM carbon, SRF-HM carbon, and MT carbon, among which MT carbon is preferable.

The shape of the inorganic filler is not particularly limited, and may be fibrous, plate-like, or particulate (including spherical). From the viewpoint of mechanical properties and friction and wear properties, the shape of the inorganic filler is preferably fibrous. In use applications for which isotropy of a molded body is required, a plate-like inorganic filler or a particulate inorganic filler is preferable. The size of the inorganic filler is not particularly limited. An inorganic filler having any of nano size, micrometer size, and millimeter size can also be used depending on use applications of a molded body.

Examples of the polymer filler include a liquid crystal polymer, a polycarbonate, a polyethylene terephthalate, a polybutylene terephthalate, a polyester elastomer, a polyarylate, a polycaprolactone, a phenoxy resin, a polysulfone, a polyether sulfone, a polyimide, a polyether imide, polyamide 6, polyamide 66, polyamide 11, polyamide 12, polyamide 610, polyamide 46, an aromatic polyamide, a polyamide elastomer, a polyphenylene oxide, a polyphenylene sulfide, a polytetrafluoroethylene, an acrylonitrile-butadiene-styrene copolymer (ABS resin), a polymethyl methacrylate, a polypropylene, a polyethylene, a polybutadiene, a butadiene-styrene copolymer, an ethylene-propylene-diene rubber (EPDM), a styrene-butadiene block copolymer, a butadiene-acrylonitrile copolymer, an acrylic rubber, a styrene-maleic anhydride copolymer, a styrene-phenyl maleimide copolymer, an ethylene/acrylic acid/glycidyl methacrylate copolymer, a silicone elastomer, and an aramid. Above all, polytetrafluoroethylene is suitably used for further reducing the dielectric constant and dielectric loss tangent of a molded body.

Examples of the plasticizer include a phthalic acid ester and an adipic acid ester.

Examples of the flame retardant include aluminum hydroxide, magnesium hydroxide, magnesium carbonate, antimony trioxide, sodium antimonate, antimony pentoxide, a phosphazene compound, a phosphoric acid ester (triphenyl phosphate, tricresyl phosphate, trixylenyl phosphate, cresyl phenyl phosphate, 2-ethylhexyl diphenyl phosphate, or the like), ammonium polyphosphate, melamine/melam/melem polyphosphate, red phosphorus, a molybdenum compound, a boric acid compound, and polytetrafluoroethylene.

### [Method for Producing Composition]

The method for producing a composition according to one aspect of the present invention (hereinafter, also referred to as the present production method) include a step of irradiating a composition precursor with ionizing radiation (irradiating step).

Before the step of irradiation with ionizing radiation, the present production method may include a step of preparing the composition precursor (preparing step).

After the preparing step and before the irradiating step, the present production method may include a step of compositing or laminating the composition precursor obtained in the preparing step with another material (compositing and laminating step).

### (Composition Precursor)

The composition precursor contains a fluorine-containing polymer and PAEK. The composition precursor may contain other components. The fluorine-containing polymer, PAEK, and other components are as described above.

The composition precursor does not have a storage elastic modulus G′ in a case of being measured at a Tm of PAEK.

In the composition precursor, the fluorine-containing polymer is dispersed in PAEK.

The number average particle diameter of the fluorine-containing polymer dispersed in PAEK is preferably 0.5 to 10 μm and more preferably 1 to 5 μm. In a case where the number average particle diameter of the fluorine-containing polymer is equal to or more than the lower limit value, the impact resistance and the workability of the present composition are more excellent, and in a case where the number average particle diameter of the fluorine-containing polymer is equal to or less than the upper limit value, the dispersion uniformity of the fluorine-containing polymer is more excellent.

Further, the number average particle diameter of the fluorine-containing polymer dispersed in PAEK does not change before and after the irradiation with ionizing radiation. That is, the number average particle diameter of the fluorine-containing polymer in the composition precursor and the number average particle diameter of the fluorine-containing polymer in the composition to be obtained are the same.

The composition precursor preferably satisfies any one or more of the following requirements 1 to 4. In a case where the composition precursor satisfies any one or more of the requirements 1 to 4, crosslinking proceeds efficiently in a case where the composition precursor is irradiated with ionizing radiation, and the storage elastic modulus of the composition precursor in a case of being measured at the Tm of PAEK is easily set to 0.1 MPa or more.

Requirement 1: The tensile strength after irradiation of the composition precursor with 10 MGy of ionizing radiation is 1.1 times or more with respect to the tensile strength before the irradiation.

Requirement 2: The tensile elongation after irradiation of the composition precursor with 1 MGy of ionizing radiation is 0.85 times or less with respect to the tensile elongation before the irradiation.

Requirement 3: The tensile elongation after irradiation of the composition precursor with 5 MGy of ionizing radiation is 0.85 times or less with respect to the tensile elongation before the irradiation.

Requirement 4: The tensile elongation after irradiation of the composition precursor with 10 MGy of ionizing radiation is 0.75 times or less with respect to the tensile elongation before the irradiation.

Hereinafter, the tensile strength (MPa) after the irradiation with ionizing radiation is also referred to as Sa, and the tensile strength (MPa) before the irradiation with ionizing radiation is also referred to as Sb. In addition, the tensile elongation (%) after the irradiation with ionizing radiation is also referred to as Ea, and the tensile elongation (%) before the irradiation with ionizing radiation is also referred to as Eb.

The requirement 1 is also expressed as Sa/Sb≥1.1. In the requirement 1, Sa/Sb is preferably 1.15 or more and more preferably 1.2 or more. In addition, Sa/Sb is preferably 8.0 or less and more preferably 4.0 or less from the viewpoint of flexibility.

The requirement 2 is also expressed as Ea/Eb≤0.85. In the requirement 2, Ea/Eb is preferably 0.84 or less and more preferably 0.82 or less. In addition, Ea/Eb is preferably 0.01 or more and more preferably 0.1 or more from the viewpoint of flexibility.

The requirement 3 is also expressed as Ea/Eb≤0.85. In the requirement 3, Ea/Eb is preferably 0.8 or less and more preferably 0.5 or less. In addition, Ea/Eb is preferably 0.01 or more and more preferably 0.1 or more from the viewpoint of flexibility.

The requirement 4 is also expressed as Ea/Eb≤0.75. In the requirement 4, Ea/Eb is preferably 0.6 or less and more preferably 0.4 or less. In addition, Ea/Eb is preferably 0.01 or more and more preferably 0.1 or more from the viewpoint of flexibility.

Sa/Sb or Ea/Eb can be adjusted by, for example, the proportion of the fluorine-containing polymer with respect to the total mass of the fluorine-containing polymer and PAEK, the irradiation dose, and the crosslinking agent. For example, as the proportion of the fluorine-containing polymer increases, Sa/Sb tends to increase and Ea/Eb tends to decrease.

In the composition precursor, the proportion of the fluorine-containing polymer with respect to the total mass of the fluorine-containing polymer and PAEK is preferably 1% to 60% by mass, more preferably 5% to 40% by mass, and still more preferably 10% to 30% by mass. In a case where the proportion of the fluorine-containing polymer is equal to or more than the lower limit value, the crosslinking density of the present composition can be sufficiently increased, and in a case where the proportion of the fluorine-containing polymer is equal to or less than the upper limit value, the fluorine-containing polymer can be easily dispersed in PAEK, and the excellent properties of PAEK can be exhibited.

The proportion of the total mass of the fluorine-containing polymer and PAEK with respect to the total mass of the composition precursor is preferably 10% by mass or more, more preferably 50% by mass or more, and still more preferably 70% by mass or more, and may be 100% by mass.

Before and after the irradiation with ionizing radiation, the proportion of the fluorine-containing polymer with respect to the total mass of the fluorine-containing polymer and PAEK and the proportion of the total mass of the fluorine-containing polymer and PAEK with respect to the total mass of the composition precursor do not change.

The MFR of the composition precursor is preferably 2 to 300 g/10 min, more preferably 3 to 200 g/10 min, and still more preferably 5 to 100 g/10 min. In a case where the MFR of the composition precursor is equal to or more than the lower limit value, the moldability and the strength of the composition to be obtained are more excellent, and in a case where the MFR of the composition precursor is equal to or less than the upper limit value, the MFR of the composition to be obtained is likely to be equal to or less than the above-mentioned preferable upper limit value.

### (Preparing Step)

The composition precursor can be obtained, for example, by melt-kneading the fluorine-containing polymer, PAEK, and other components as necessary. After the melt-kneading, the obtained kneaded product may be molded as necessary.

The melt-kneading can be carried out using a conventionally known melt-kneading device.

The melt-kneading device may be any device as long as it has a melt-kneading function. The melt-kneading device is preferably a single-screw extruder or twin-screw extruder which may be equipped with a screw having a high kneading effect, more preferably a twin-screw extruder, and particularly preferably a twin-screw extruder equipped with a screw having a high kneading effect. A screw having a sufficient kneading effect on a melt-kneading target and not applying an excessive shearing force can be selected as the screw having a high kneading effect. Examples of the melt-kneading device include a LABO PLASTOMILL kneader (manufactured by Toyo Seiki Seisaku-sho, Ltd.) and a KZW series twin-screw kneading extruder (manufactured by Technovel Corporation).

Examples of the method of supplying the fluorine-containing polymer and PAEK to the melt-kneading device include a method in which the fluorine-containing polymer and PAEK are mixed in advance and supplied to the melt-kneading device, and a method in which the fluorine-containing polymer and PAEK are separately supplied to the melt-kneading device.

In a case where the composition precursor contains other components, the other components may be mixed in advance with one of the fluorine-containing polymer and PAEK and supplied to the melt-kneading device, or may be supplied to the melt-kneading device separately from the fluorine-containing polymer and PAEK. In addition, the other components may be added after the fluorine-containing polymer and PAEK are melt-kneaded.

The temperature in a case where the fluorine-containing polymer and PAEK are melt-kneaded (hereinafter, also referred to as “melt-kneading temperature”) is preferably 200° C. to 550° C., more preferably 220° C. to 480° C., and still more preferably 280° C. to 450° C. In a case where the melt-kneading temperature is equal to or higher than the lower limit value, the dispersibility of the fluorine-containing polymer in PAEK is more excellent, and in a case where the melt-kneading temperature is equal to or lower than the upper limit value, the thermal deterioration of PAEK can be suppressed.

The extrusion shear rate in a case of melt-kneading the fluorine-containing polymer and PAEK is preferably set according to the melt viscosity of the melt-kneading target consisting of the fluorine-containing polymer and PAEK at the melt-kneading temperature. The extrusion shear rate in the melt-kneading is preferably 3 to 2,500 seconds⁻¹, more preferably 10 to 2,000 seconds⁻¹, and still more preferably 15 to 1,500 seconds⁻¹.

The residence time of the melt-kneading target in the melt-kneading device is preferably 10 to 290 seconds, more preferably 20 to 240 seconds, and still more preferably 30 to 210 seconds.

The melt-kneading of the fluorine-containing polymer and PAEK is preferably carried out so that particles of the fluorine-containing polymer having a number average particle diameter of 0.5 to 10 μm are dispersed in PAEK. The particles of the fluorine-containing polymer having a number average particle diameter of 0.5 to 10 μm can be dispersed in PAEK by appropriately adjusting the melt-kneading temperature, the extrusion shear rate, and the residence time of the melt-kneading target in the melt-kneading device.

By increasing the melt-kneading temperature, the fluorine-containing polymer is easily dispersed in PAEK, and coarse particles of the fluorine-containing polymer are less likely to remain. By decreasing the melt-kneading temperature, heat decomposition of the fluorine-containing polymer is less likely to be promoted, the heat resistance of the resin composition is more excellent, and the particle diameter of the fluorine-containing polymer is not reduced too much.

By increasing the extrusion shear rate, the fluorine-containing polymer is easily dispersed in PAEK, and coarse particles of the fluorine-containing polymer are less likely to remain. By decreasing the extrusion shear rate, the particle diameter of the fluorine-containing polymer is not reduced too much.

In a case where the residence time of the melt-kneading target in the melt-kneading device is lengthened, the fluorine-containing polymer is easily dispersed in PAEK, and coarse particles of the fluorine-containing polymer are less likely to remain. In a case where the residence time is shortened, the heat decomposition of the fluorine-containing polymer is less likely to be promoted.

Typically, the melt-kneading is carried out in the substantial absence of a crosslinking agent and a crosslinking aid. The melt-kneading in the substantial absence of a crosslinking agent and a crosslinking aid means that PAEK and the fluorine-containing polymer in the composition precursor are melt-kneaded without substantially crosslinking them. It is preferable that PAEK and the fluorine-containing polymer in the composition precursor have neither a structure derived from the crosslinking agent nor a structure derived from the crosslinking aid. Whether PAEK and the fluorine-containing polymer in the composition precursor are substantially not crosslinked can be confirmed by the value of the storage elastic modulus G′ of the composition precursor in a case of being measured at the Tm of PAEK.

For the purpose of controlling the degree of the anti-drip properties, the melt-kneading may be carried out in the presence of either or both of the crosslinking agent and the crosslinking aid.

Examples of the crosslinking agent include an organic peroxide, sulfur, an aromatic diol, a thiol, a triazine-based crosslinking agent, and a quinoxaline-based crosslinking agent. Among these, an organic peroxide is preferable.

Specific examples of the organic peroxide include an dialkyl peroxide, α,α′-bis(tert-butylperoxy)-p-diisopropylbenzene, α,α′-bis(tert-butylperoxy)-m-diisopropylbenzene, benzoyl peroxide, tert-butylperoxybenzene, 2,5-dimethyl-2,5-di(benzoylperoxy)hexane, tert-butylcumyl peroxide, and dicumyl peroxide.

Specific examples of the dialkyl peroxide include 1,1-di(tert-butylperoxy)-3,3,5-trimethylcyclohexane, 2,5-dimethylhexane-2,5-dihydroxyperoxide, 2,5-dimethyl-2,5-di(tert-butylperoxy)hexane, 2,5-dimethyl-2,5-di(tert-butylperoxy)-3-hexine, tert-butylperoxymaleic acid, and tert-butyl peroxyisopropyl carbonate.

Examples of the crosslinking aid include triallyl cyanurate, triallyl isocyanurate, trimethallyl isocyanurate, monoglycidyl diallyl isocyanurate, diglycidyl monoallyl isocyanurate, a triallyl isocyanurate prepolymer, trimethylolpropane triacrylate, and trimethylallyl isocyanurate.

The obtained kneaded product is molded to obtain a molded body consisting of the composition precursor.

The molding method may be, for example, a melt molding method. Examples of the melt molding method include an injection molding method, an extrusion molding method, a coextrusion molding method, a blow molding method, a compression molding method, a transfer molding method, and a calender molding method.

In a case where the molded body is a film, an extrusion molding method such as a T-die method or an inflation method is preferable as the molding method. In the T-die method, the flow rate adjustment of the molten resin and the thickness of the film can be precisely controlled by adjusting a choke bar and a lip inside the T-die. In the inflation method, air is introduced into an extruded product from a circular die to expand the extruded product to obtain a film, thereby making the thickness of the film uniform.

In a case where the molded body is a fiber, the molding method is preferably an extrusion molding method such as a melt spinning method.

Further, the molding of the kneaded product by the melt molding method may be continuously carried out following the melt-kneading of the fluorine-containing polymer and PAEK.

### (Compositing and Laminating Step)

Examples of the other material to be composited or laminated with the composition precursor include a metal, a glass, a plastic, and a rubber.

Specific examples of the plastic include those described in PCT International Publication No. WO2015/182702, a liquid crystal polymer, a polyarylketone, a polyethersulfone, a polyphenylsulfone, a polyacetal, and a polyurethane. Examples of the polyamide include polyamide 6, polyamide 66, polyamide 46, polyamide 11, polyamide 12, polyamide 610, polyamide 612, a polyamide 6/66 copolymer, a polyamide 6/66/610 copolymer, polyamide MXD6, polyamide 6T, polyamide 9T, and a polyamide 6/6T copolymer.

Among these, a metal or a glass is preferable as the other material. Iron, copper, stainless steel, steel, aluminum, magnesium, titanium, or the like is preferable as the metal.

The method of compositing and laminating is not particularly limited, and various methods can be adopted. Examples of the method of compositing and laminating include a method in which a molded body consisting of a composition precursor is bonded to another material such as a metal coated with an adhesive; a method in which a molten composition precursor is injection molded onto a metal member installed in a mold in injection molding; and a method in which a composition precursor is powdered and coated on another material.

In a case of being composited with a metal by injection molding, the composition precursor can be composited with a metal member as it is, or the composition precursor can be injection molded onto a metal member after a chemical bonding treatment or a physical or chemical unevenness forming treatment is carried out on the surface of the metal member. A metal member coated with an adhesive can be used as the chemical bonding treatment. Examples of the physical unevenness forming treatment include laser processing and mechanical processing. Examples of the chemical unevenness forming treatment include chemical etching.

After the injection molding, the obtained composite body may be further processed into a desired shape by mechanical processing or cutting machining.

### (Irradiating Step)

Examples of the ionizing radiation include an electron beam, radiation, a gamma ray, an alpha ray, a beta ray, an X-ray, and a neutron beam. Among these, an electron beam is preferable from the viewpoint of plastic modification properties.

The irradiation with ionizing radiation can be carried out using a conventionally known ionizing radiation irradiation device.

The irradiation amount of ionizing radiation is set such that the composition precursor after irradiation with ionizing radiation, that is, the present composition has a storage elastic modulus G′ of 0.1 MPa or more in a case of being measured at the Tm of PAEK. The preferred storage elastic modulus G′ of the composition precursor after irradiation with ionizing radiation is the same as the preferred storage elastic modulus G′ of the present composition described above.

The irradiation amount of ionizing radiation is preferably 0.05 to 100 MGy, more preferably 0.1 to 60 MGy, and still more preferably 0.5 to 30 MGy. In a case where the irradiation amount is equal to or higher than the lower limit value, the storage elastic modulus G′ of the composition precursor after the irradiation, that is, the present composition is likely to be 0.1 MPa or more, and in a case where the irradiation amount is equal to or lower than the upper limit value, the flexibility tends to be excellent.

1 Gy (gray) is an absorption dose in a case where 1 J of energy is absorbed by 1 g of a substance (composition precursor) by ionizing radiation.

The atmospheric temperature at the time of irradiation with ionizing radiation is preferably 500° C. or lower, and more preferably 300° C. or lower. The lower limit of the atmospheric temperature is not particularly limited and is, for example, −100° C. In a case where the atmospheric temperature is equal to or lower than the upper limit value, thermal deterioration of PAEK can be suppressed.

By irradiation with ionizing radiation as described above, the composition precursor becomes the present composition.

In a case where the composition precursor is formed into a molded body, a molded body consisting of the present composition is obtained.

In a case where the composition precursor is composited or laminated with another material, a composite body is obtained in which a molded body consisting of the present composition and the other material are composited or laminated.

Examples of specific forms and use applications of the molded body or composite body include a housing of a portable electronic device, a coupling member of a portable electronic device, a sliding member, a three-dimensional circuit component, a gear, an actuator, a piston, a bearing, an aircraft interior material, a bush, a tube (for fuel or the like), a hose, a tank, a seal, a wire, an insulation covering material for an electric wire (a wire, a cable, or the like), a film, a sheet, a bottle, and a fiber.

Examples of the portable electronic device include a mobile phone, a mobile terminal, a laptop computer, a tablet computer, a radio, a camera, a camera accessory, a clock, a calculator, a music player, a global positioning system receiver, a portable game, a hard drive, a portable recording device, a portable playback device, and a portable radio receiver.

Examples of the form of the housing of the portable electronic device include a back cover, a front cover, an antenna housing, a frame, and a backbone of the portable electronic device. The housing may be a member consisting of a single component of the molded body of the present invention or a member consisting of a plurality of components. Here, the backbone is a member to which components of the portable electronic device, such as electronics, a microprocessor, a screen, a keyboard, a keypad, an antenna, and a battery socket, are attached.

In a case where the housing is inside the portable electronic device, the housing may not be visible from the outside of the portable electronic device or may be partially visible from the outside of the portable electronic device. A housing such as a cover for protecting and supporting an internal structure may be exposed to the outside of the portable electronic device.

Examples of the form of the coupling member of the portable electronic device include snap-fit connectors between a circuit board, a microphone, a speaker, a display, a battery, a cover, an electric connector, an electronic connector, a hinge, an antenna, a switch, and a switch pad of the portable electronic device. The coupling member can be suitably applied to portable electronic devices such as a mobile phone, a mobile terminal (PDA), a music storage device, an eavesdropping device, a portable DVD player, an electric multimeter, a portable electronic game machine, and a portable personal computer (for example, a notebook computer).

The three-dimensional circuit component is a component in which a circuit pattern is formed on the surface of a resin component molded into a three-dimensional shape, and is used as an antenna component of portable electronic devices or a component of in-vehicle electronic devices. As a method for forming a circuit pattern, a laser direct structuring (LDS) method is used in which the circuit pattern is etched with a laser and then a plating treatment is carried out. The molded body of the present invention has excellent low dielectric properties and can be suitably applied to a three-dimensional circuit component.

Use applications of the tube, the hose, the tank, the seal, and the wire include those described in PCT International Publication No. WO2015/182702. In addition, examples of use applications of the tube and the hose include tubes for drilling energy resources such as oil, natural gas, and shale oil.

Examples of use applications of the insulation covering material for an electric wire include an insulation covering material for an electric wire or a rectangular copper wire for a motor coil, particularly, an insulation covering material for a rectangular conductor in a driving motor of a hybrid vehicle (HEV) or an electric vehicle (EV). A film is preferable as the form of the insulation covering material for a rectangular conductor. In addition, examples of use applications of the insulation covering material for an electric wire include an insulation covering material for a downhole cable for drilling energy resources (oil, natural gas, shale oil, and the like). Above all, an insulation covering material for a downhole cable for oil drilling is preferable.

Examples of use applications of the film and the sheet include speaker diaphragms, plates for external wounds or bone fractures, insulating papers such as various electrical insulation adhesive tapes (insulating paper for a motor, and the like), sealing tapes or the like for oil and natural gas pipes, and release films at the time of molding of thermosetting and thermoplastic composite materials.

In a case where the molded body is a film, the use application thereof is preferably in a speaker diaphragm provided with a film, a film for covering an electric wire, a flexible printed substrate, a rigid substrate, a coverlay, a housing for an electronic device, a heat-resistant roll for OA equipment, or a film for film impregnation of other fiber composite materials. The thickness of the film is preferably 1 to 100 μm, more preferably 2 to 80 μm, and still more preferably 5 to 50 μm. In a case where the thickness of the film is equal to or more than the lower limit value of the above-described range, the strength of the film is improved. In a case where the thickness of the film is equal to or less than the upper limit value of the above-described range, the handleability of the film in the next step is excellent.

In a case where the molded body is a tube, the use application thereof is preferably in a medical catheter provided with a tube, an electric wire covering, or a piping for an analytical instrument.

In a case where the molded body is a fiber, the use application thereof is preferably in protective garments or various filters.

### (Mechanism of Action)

The composition precursor contains a fluorine-containing polymer and thus can be crosslinked by ionizing radiation while being based on PAEK having high ionizing radiation resistance. In a case where the composition precursor is irradiated with ionizing radiation, a crosslinked structure is formed and a composition having a storage elastic modulus G′ of 0.1 MPa or more in a case of being measured at the Tm of PAEK is obtained. In a case where the storage elastic modulus G′ of the composition in a case of being measured at the Tm of PAEK is 0.1 MPa or more, the crosslinking density is sufficiently high and the anti-drip properties are excellent.

In addition, in the related art, in a case of crosslinking PAEK, it was thermally crosslinked by addition of a low molecular weight crosslinking compound and an annealing treatment at a high temperature. In the present production method, it is possible to crosslink PAEK without adding a low molecular weight crosslinking compound or carrying out an annealing treatment, and it is possible to suppress deterioration of physical properties of PAEK due to the crosslinking compound or heat. In addition, it is possible to improve the crosslinking treatment speed and reduce the cost.

### EXAMPLES

Hereinafter, the present invention will be described in more detail with reference to Examples, but the present invention is not limited to the description of the following Examples. Examples 1 to 3 are Working Examples, and Examples 4 to 7 are Comparative Examples.

### [Evaluation Method]

### (Tm)

A melting peak in a case where the temperature of a sample was raised at a rate of 10° C./min was recorded using a differential scanning calorimeter (DSC7020, manufactured by Hitachi High-Tech Corporation), and the temperature (° C.) corresponding to a maximum value of the melting peak was defined as Tm.

### (Storage Elastic Modulus)

The storage elastic modulus G′ of a sheet in a case of being measured at the Tm of PAEK was measured in accordance with ASTM D6204.

### (Mooney Viscosity)

The Mooney viscosity (ML₁₊₁₀, 121° C.) was measured in accordance with JIS K 6300-1:2000 (corresponding international standards ISO 289-1:2005 and ISO 289-2:1994).

### (Tensile Strength and Tensile Elongation)

From a sheet having a thickness of 1 mm prepared in each of the examples, a dumbbell-shaped test piece (thickness: 1 mm) specified in ASTM D638 TYPE V was cut out.

The test piece was subjected to a tensile test using a tensile tester (TENSILON universal tester, manufactured by A&D Company, Limited) in accordance with ASTM D638 to determine the tensile strength and tensile elongation.

### (Anti-Drip Properties)

The MFR of the composition was determined under the conditions of a temperature of 372° C. and a load of 49 N in accordance with ASTM D1238. Based on the results, the anti-drip properties were evaluated according to the following standards.
A: MFR is 1.0 g/10 min or less.
B: MFR is more than 1.0 g/10 min.

### (Heat Deformation Resistance Test)

A square sample measuring 4 mm×4 mm×0.5 mm thick was cut out from a 0.5 mm thick sheet prepared in each of the examples.

A TMA curve of the obtained sample was measured using a thermomechanical analysis (TMA) device (TMA/SS6100, manufactured by Hitachi High-Tech Corporation) in accordance with JIS K 7196 (measurement mode: needle-in mode) under the conditions of temperature setting: 30° C. to 390° C., rate of temperature increase: 5° C./min, and load: 100 mN. In the TMA curve, in a case where the absolute value of the amount of deformation of the sample due to a needle (probe indenter) at the melting point of PAEK was more than 150 μm, it was determined that deformation was “present”, and in a case where the absolute value of the amount of deformation of the sample was 150 μm or less, it was determined that deformation was “absent”.

### [Material Used]

Fluorine-containing polymer: tetrafluoroethylene-propylene copolymer (MFR: 11 g/10 min, specific gravity: 1.55, Mooney viscosity (ML₁₊₁₀, 121° C.): 100, storage elastic modulus G′ (100° C., 50 cpm): 390, AFLAS (registered trademark) 150FC, manufactured by AGC Inc.).

PAEK: PEEK (Tm: 343ºC, MFR: 22 g/10 min, specific gravity: 1.32, VestaKeep 3300G, manufactured by Polyplastics-Evonik Corporation).

### Examples 1 to 7

### (Preparation of Composition Precursor)

The above-mentioned materials were mixed in the formulation shown in Table 1, supplied to a base end of a screw of a twin-screw melt kneader (KZW15TW-45HG1100, manufactured by Technovel Corporation), and melt-kneaded under the following conditions. The melt-kneaded product was extruded from a tip of a die, and the extruded strand was cooled in a water tank and cut with a pelletizer to obtain a pellet-shaped composition precursor.

Screw diameter: 15 mm, L/D: 45, screw rotation speed: 200 rpm, cylinder: cylinder that includes a first block C1, a second block C2, a third block C3, a fourth block C4, a fifth block C5, and a sixth block C6 in order from the base end side, and temperature pattern (set temperature of each of blocks C1 to C6 of the cylinder, the die (D), and the head (H)): C1=340° C., C2=350° C., C3=360° C., C4=370° C., C5=370° C., C6=370° C., D=350° C., and H=350° C.

### (Preparation of Sheet)

The pellet-shaped composition precursor was molded using a heat press machine manufactured by Tester Sangyo Co., Ltd. under the conditions of a processing temperature of 370° C., a preheat of 10 minutes, a pressure of 10 MPa, and a press time of 3 minutes to obtain a sheet having a thickness of 1 mm. In Examples 1 to 3 and 7, furthermore, the molded sheet was irradiated with ionizing radiation (electron beam) using EPS750 manufactured by NHV Corporation. Three types of ionizing radiation (electron beam) were used: 1 MGy, 5 MGy, and 10 MGy.

In Examples 4 to 6, sheets were obtained by carrying out the same operation as described above except that the thickness of the sheet was separately set to 0.5 mm. In Examples 4 to 6, the molded sheets were not irradiated with ionizing radiation (electron beam).

For the sheet having a thickness of 1 mm of each of the examples, the storage elastic modulus G′ of the sheet in a case of being measured at the Tm of PAEK, and the anti-drip properties were evaluated. Table 1 shows the results. In this regard, for Examples 1 to 3 and 7, the storage elastic modulus G′ of the sheet irradiated with 10

MGy of ionizing radiation in a case of being measured at the Tm of PAEK was measured. The sheets of Examples 4 to 6 which were not irradiated with ionizing radiation were thermally deformed at the Tm of PAEK, and the storage elastic modulus could not be measured. It should be noted that in Examples 1 to 3, the MFR was 1 g/10 min or less and the measurement accuracy was low, so the specific numerical value of the MFR was not shown.

In addition, a tensile strength Sb and a tensile elongation Eb before the irradiation with ionizing radiation, and a tensile strength Sa and a tensile elongation Ea after the irradiation with ionizing radiation were measured for the sheets having a thickness of 1 mm of Examples 1 to 3 and 7, and the values of Sa/Sb and Ea/Eb were determined. Table 1 shows the results. “n/a” indicates that measurement was not carried out (the same applies hereinafter).

In addition, the heat deformation resistance of the sheets having a thickness of 0.5 mm of Examples 4 to 6 was evaluated. Table 1 shows the results. The sample deformation amount was described together with the evaluation results of heat deformation resistance.

TABLE 1

| | | Example 1 | Example 2 | Example 3 | Example 4 | Example 5 | Example 6 | Example 7 |
|---|---|---|---|---|---|---|---|---|
| Formulation | Fluorine-containing | 10 | 20 | 30 | 10 | 20 | 30 | — |
| (wt %) | polymer | | | | | | | |
| | PAEK (Tm 343° C.) | 90 | 80 | 70 | 90 | 80 | 70 | 100 |

| | | | | | | | |
|---|---|---|---|---|---|---|---|
| With or without ionizing radiation | Irradiation | Irradiation | Irradiation | No | No | No | Irradiation |
| irradiation | | | | irradiation | irradiation | irradiation | |
| Storage elastic modulus G′ (MPa) | 0.9 | 2 | 2.7 | Not | Not | Not | 0.11 |
| at PAEK-Tm | | | | measurable | measurable | measurable | |
| | | | | due to heat | due to heat | due to heat | |
| | | | | deformation | deformation | deformation | |
| Ionizing radiation irradiation 10 MGy | 1.2 | 1.3 | 1.4 | n/a | n/a | n/a | 0.8 |
| Sa/Sb | | | | | | | |
| Ionizing radiation irradiation 1 MGy | 0.82 | 1.02 | 0.42 | n/a | n/a | n/a | 0.87 |
| Ea/Eb | | | | | | | |
| Ionizing radiation irradiation 5 MGy | 0.35 | 0.21 | 0.23 | n/a | n/a | n/a | 0.88 |
| Ea/Eb | | | | | | | |
| Ionizing radiation irradiation 10 MGy | 0.15 | 0.09 | 0.08 | n/a | n/a | n/a | 0.77 |
| Ea/Eb | | | | | | | |
| Anti-drip properties | Having | Having anti- | Having anti- | Not having | Not having | Not having | Not having |
| (MFR, g/10 min) | anti-drip | drip | drip | anti-drip | anti-drip | anti-drip | anti-drip |
| | properties | properties | properties | properties | properties | properties | properties |
| | | | | (18.5) | (17.5) | (16.6) | (19.8) |
| Heat deformation resistance | n/a | Not having heat | n/a | n/a | Having heat | n/a | Having heat |
| @TMA, melting point (343° C.) | | deformation | | | deformation | | deformation |
| | | resistance | | | resistance | | resistance |
| | | (10 MGy | | | (−481 μm) | | (−158 μm) |
| | | irradiation, −59 | | | | | |
| | | μm) | | | | | |

The sheets of Examples 1 to 3 had anti-drip properties. In addition, in the evaluation of heat deformation resistance in Example 2, there was “no deformation”, indicating excellent heat resistance.

On the other hand, the sheets of Examples 4 to 6 not irradiated with ionizing radiation did not have anti-drip properties. In addition, in the evaluation of heat deformation resistance in Example 5, there was “deformation”, indicating poor heat resistance.

The sheet of Example 7 containing no fluorine-containing polymer had a storage elastic modulus in a case of being measured at the Tm of PAEK, but did not have anti-drip properties. In addition, there was “deformation” in the evaluation of heat deformation resistance, indicating poor heat resistance.

### INDUSTRIAL APPLICABILITY

According to the present invention, it is possible to provide a composition based on a polyaryletherketone and having excellent anti-drip properties, and a method for producing the same.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description and is only limited by the scope of the appended claims.

What is claimed is:

1. A composition comprising:
a fluorine-containing polymer; and
a polyaryletherketone,
wherein the fluorine-containing polymer is dispersed in the polyaryletherketone, and
a storage elastic modulus G′ of the composition at a melting point of the polyaryletherketone is 0.1 MPa or more.

2. The composition according to claim 1, wherein the fluorine-containing polymer has no melting point.

3. The composition according to claim 1, wherein a Mooney viscosity (ML₁₊₁₀, 121° C.) of the fluorine-containing polymer is 10 to 300.

4. The composition according to claim 1, wherein the melting point of the polyaryletherketone is 340° C. or higher.

5. The composition according to claim 1, wherein, in a TMA curve measured in accordance with JIS K 7196 for a sample consisting of the composition, an absolute value of a sample deformation amount at the melting point of the polyaryletherketone is 150 μm or less.

6. A method for producing a composition, the method comprising:
irradiating a composition precursor with ionizing radiation,
wherein the composition precursor contains a fluorine-containing polymer and a polyaryletherketone,
the fluorine-containing polymer is dispersed in the polyaryletherketone,
the composition precursor does not have a storage elastic modulus G′ at a melting point of the polyaryletherketone, and
an irradiation amount of the ionizing radiation is set so that the storage elastic modulus G′ of the composition at the melting point of the polyaryletherketone is 0.1 MPa or more in a case where the composition precursor is irradiated with the ionizing radiation.

7. The method for producing a composition according to claim 6, wherein the composition precursor satisfies the following requirement 1,
Requirement 1: a tensile strength after irradiation of the composition precursor with 10 MGy of ionizing radiation is 1.1 times or more with respect to a tensile strength before the irradiation.

8. The method for producing a composition according to claim 6, wherein the composition precursor satisfies the following requirement 2,
Requirement 2: a tensile elongation after irradiation of the composition precursor with 1 MGy of ionizing radiation is 0.85 times or less with respect to a tensile elongation before the irradiation.

9. The method for producing a composition according to claim 6, wherein the composition precursor satisfies the following requirement 3,
Requirement 3: a tensile elongation after irradiation of the composition precursor with 5 MGy of ionizing radiation is 0.85 times or less with respect to a tensile elongation before the irradiation.

10. The method for producing a composition according to claim 6, wherein the composition precursor satisfies the following requirement 4,
Requirement 4: a tensile elongation after irradiation of the composition precursor with 10 MGy of ionizing radiation is 0.75 times or less with respect to a tensile elongation before the irradiation.
